(19) United States
(12) Patent Application Publication
(10) Pub. No.: US 2008/0101168 A1
(43) Pub. Date: May 1, 2008

(54) OPTICAL DISK APPARATUS AND RECORDING METHOD OF THE SAME

(75) Inventor: Toshihiko KOBAYASHI, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/857,665

(22) Filed: Sep. 19, 2007

(30) Foreign Application Priority Data
Oct. 31, 2006 (JP) 2006-295374

(51) Int. Cl. G11B 7/00

(52) U.S. Cl. 369/44.11

(57) ABSTRACT

According to one embodiment, there is provided an optical disk apparatus including: a first determination unit configured to set a reference tracking offset and determine a reference recording power by an optimum power control processing; a tracing unit configured to trace a predetermined area in an optical disk by changing the tracking offset through use of an erase power calculated from the reference recording power; an acquisition unit configured to acquire an address information acquisition rate serving as a rate for reading address information, when data are traced in the predetermined area of the optical disk by changing the tracking offset within a predetermined range by the tracing unit; a second determination unit configured to determine, from the address read rate, a recording-operation tracking offset used during processing for recording the data into the optical disk; and an adjustment unit configured to adjust the recording-operation tracking offset.

### CROSS-REFERENCE TO RELATED APPLICATIONS

This application is based upon and claims the benefit of priority from Japanese Patent Application No. 2006-295374, filed Oct. 31, 2007, the entire contents of which are incorporated herein by reference.

### BACKGROUND

1. Field

One embodiment of the invention relates to an optical disk apparatus and a recording method of the optical disk apparatus, and more particularly, to an optical disk apparatus and a recording method thereof which enable adjustment of a tracking offset during recording operation.

2. Description of the Related Art

In general, in order to accurately detect the position of a track (hereinafter called a “track position”) when information is recorded on an optical disk and to reproduce the information recorded on the optical disk, a tracking error signal is generated by detecting an offset between the track position and the position of a beam spot (hereinafter called a “beam spot position”), and tracking servo is performed in accordance with the thus-generated tracking error signal. Specifically, tracking servo is performed such that the generated tracking error signal becomes zero.

However, since an optimum tracking offset varies according to the type of a recording medium or reflectance, tracking servo cannot be performed accurately in response to variations in the type of a recording medium or reflectance, and a beam spot undergoes tracking servo with the beam spot position slightly deviated from a predetermined track position toward an inner track side or an outer track side.

Particularly, the power (the quantity of light) and a gain of a laser beam to be emitted changes from a reproduction operation to a recording operation. Hence, an optimum tracking offset varies from a reproduction operation to a recording operation. However, the optimum tracking offset is not inevitably proportional to the power (the quantity of light) and a gain of the laser beam emitted during reproduction or recording operation. Difficulty is encountered in previously determining an optimum tracking offset during recording operation.

It is disclosed by, for example, US2002/122362 A1 that an optimum tracking offset during recording operation can be determined.

According to the technique disclosed in US2002/122362 A1, a plurality of frames in the optical disk are subjected to experimental recording by rendering variable a tracking offset employed in recording operation, and an optimum tracking offset can be computed and determined from characteristic values acquired for each of frames of a signal generated by reproducing experimentally-recorded portions of the plurality of frames. As a result, an optimum tracking offset can be determined during recording operation, and the chance of occurrence of reproduction jitter can be diminished.

Further, there has been known a technique of creating a quasi-recording state at the time of determination of an optimum tracking offset during reproduction operation; and determining a tracking offset optimum for the created quasi-recording state as a tracking offset optimum for recording operation.

Recently, there has also been proposed a technique [OPC (Optimum Power Control)] for tentatively writing test data in a predetermined area [PCA (Power Calibration Area)] of an optical disc at the time of recording of data in a recordable optical disc, such as a CD (Compact Disc)-R/RW disc or a DVD (Digital Versatile Disc)-R/RW disc, and the like, by changing recording power; and reproducing the thus-tentatively-written test data, thereby setting optimum recording power to each of the discs.

However, according to the technique disclosed in US2002/122362 A1, a plurality of frames of an optical disk are subjected to test recording by rendering variable a tracking offset acquired during recording operation, and an optimum tracking offset can be computed and determined from a characteristic value acquired on each frame of a reproduced signal created by reproducing the data in test-recorded areas of the plurality of frames. However, a recording film of an optical disk is once exposed to a beam of recording power, to thus record predetermined test data, and reproduction processing is performed subsequently. Moreover, since a recording area where the predetermined test data are recorded may be erased in a later operation, there arises a problem of much time and effort being consumed by determining an optimum tracking offset during recording operation.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the internal configuration of an optical disk drive according to an embodiment of the invention;

FIG. 2 is an exemplary descriptive view for describing a case where tracking servo operation is performed while the position of a beam spot is slightly deviated from a predetermined track position toward an inner or outer track according to the embodiment;

FIG. 3 is an exemplary flowchart for describing OPC processing in the optical disk drive shown in FIG. 1;

FIG. 4 is an exemplary graph showing a relationship between an address information read rate and a tracking offset;

FIG. 5 is an exemplary flowchart for describing other OPC processing in the optical disk drive shown in FIG. 1;

FIG. 6 is an exemplary descriptive view for describing a transient response appearing when a Power Calibration Area (PCA) of an optical disk is exposed while switching between reproduction power and erase power used as recording power computed from reference recording power;

FIG. 7 is an exemplary flowchart for describing other OPC processing in the optical disk drive shown in FIG. 1; and

FIG. 8 is an exemplary view showing a tracking error signal acquired when a track jump over a distance equivalent to one track is performed.

### DETAILED DESCRIPTION

Various embodiments according to the invention will be described hereinafter with reference to the accompanying drawings. In general, according to one embodiment of the invention, there is provided an optical disk apparatus including: a first determination unit configured to set a reference tracking offset and determine a reference recording power by an optimum power control processing; a tracing unit configured to trace a predetermined area in an optical disk by changing the tracking offset through use of an erase power calculated from the reference recording power; an acquisition unit configured to acquire an address information acquisition rate serving as a rate for reading address information, when data are traced in the predetermined area of the optical disk by changing the tracking offset within a predetermined range by the tracing unit; a second determination unit configured to determine, from the address read rate, a recording-operation tracking offset used during processing for recording the data into the optical disk; and an adjustment unit configured to adjust the recording-operation tracking offset.

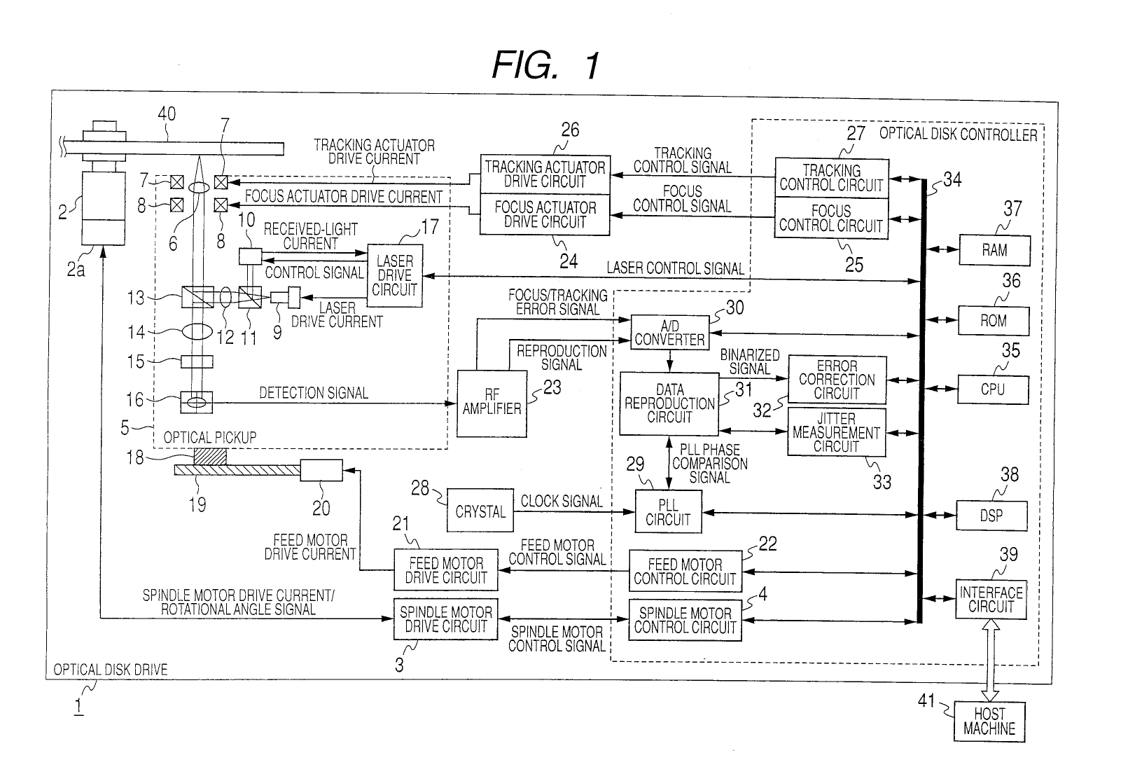

According to an embodiment, FIG. 1 exemplary shows the internal configuration of an optical disk drive 1.

The optical disk drive 1 records and reproduces information on and from an optical disk 40, such as a DVD (Digital Versatile Disc), serving as an information recording medium. Grooves are concentrically or helically inscribed in the optical disk 40. Indented sections of the groove are called lands, and protruding sections of the same are called grooves. A circular path served as grooves or lands is called a track. A laser beam of modulated intensity is radiated along this track (served as only grooves or of grooves and lands), to thus create a recording mark, whereby user data are recorded on the optical disk 40. Data are reproduced by irradiating the track with a laser beam of reading power (reproducing power), which is lower than the power used for recording; and detecting variations in the intensity of light reflected from the recording mark provided in the track. The recorded data are erased by irradiating the track with a laser beam of erase power which is higher than the reading power, thereby crystallizing the recording layer.

The optical disk 40 is rotationally driven by a spindle motor 2. A rotation angle signal is output from an accompanying rotary encoder 2a of the spindle motor 2 to a spindle motor drive circuit 3. When the spindle motor 2 rotates once, five pulses, for instance, are generated as a rotation angle signal. As a result, a spindle motor control circuit 4 can determine, by a spindle motor drive circuit 3, the rotational angle and the number of rotations of the spindle motor 2 from the rotation angle signal input by the rotary encoder 2a. This spindle motor 2 is controlled by the spindle motor control circuit 4.

Information is recorded on or reproduced from the optical disk 40 by an optical pickup 5. The optical pickup 5 is coupled to a feed motor 20 by a gear 18 and a screw shaft 19. This feed motor 20 is controlled by a feed motor drive circuit 21. As a result of the motor 20 being rotated by a feed motor drive current supplied by a feed motor drive circuit 21, the optical pickup 5 is moved in the radial direction of the optical disk 40.

The optical pickup 5 is provided with an objective lens 6 supported by an unillustrated wire or leaf spring. The objective lens 6 can be moved in a focusing direction (the direction of the optical axis of the lens) by driving operation of a focus actuator 8. In addition, the objective lens 6 can also be moved in a tracking direction (a direction orthogonal to the optical axis of the lens) by driving operation of a tracking actuator 7.

At the time of recording of information (at the time of creation of a mark), a laser drive circuit 17 supplies a laser diode (a laser-emitting element) 9 with a write signal in accordance with the record data supplied from a host machine 41 by an interface circuit 39. At the time of reading of information, the laser drive circuit 17 supplies the laser diode 9 with a read signal which is lower in power than the write signal.

A front monitor photodiode 10 bifurcates a portion of the laser beam generated by the laser diode 9 at only a given ratio by a half mirror 11; detects a received-light signal proportional to the quantity of light or radiation power; and supplies the detected received-light signal to the laser drive circuit 17. The laser drive circuit 17 acquires the received-light signal supplied by the front monitor photodiode 10, and controls the laser diode 9 in accordance with the thus-acquired received-light signal in such a way that light is emitted at reproducing laser power (radiation power), recording laser power, and erase laser power which have previously been set by the CPU 35.

The laser diode 9 emits a laser beam in response to a signal supplied by the laser drive circuit 17. The optical disk 40 is irradiated with the laser beam emitted by the laser diode 9 by a collimator lens 12, a half prism 13, and the objective lens 6. The light reflected from the optical disk 40 is guided to a photodetector 16 by the objective lens 6, the half prism 13, a condenser lens 14, and a cylindrical lens 15.

The photodetector 16 is formed from, e.g., a quadrant photodetector cell; generates a detection signal; and outputs the thus-generated detection signal to an RF amplifier 23. The RF amplifier 23 processes the detection signal from the photodetector 16, to thus generate a focus error (FE) signal showing a deviation from focus, a tracking error (TE) signal showing a deviation between the beam spot center of the laser beam and the center of a track, and a reproduction (RF) signal corresponding to a total addition of detection signals; and supplies an A/D converter 30 with the thus-generated focus error (FE) signal, the tracking error (TE) signal, and the reproduction (RF) signal.

In accordance with the focus error (FE) signal from an RF amplifier 23 captured by a DSP 38 via the A/D converter 30, a focus control circuit 25 generates a focus control signal, and supplies a focus actuator drive circuit 24 with the thus-generated focus control signal. In accordance with the focus control signal supplied by the focus control circuit 25, the focus actuator drive circuit 24 supplies the focus actuator 8 with a focus actuator drive current for actuating the focus actuator 8 in a focusing direction. Thus, there is performed focusing servo operation by which the laser beam comes into just focus on the recording film of the optical disk 40 at all times.

In accordance with the tracking error (TE) signal from the RF amplifier 23 captured by the DSP 38 by the A/D converter 30, a track control circuit 27 generates a track control signal, and supplies a tracking actuator drive circuit 26 with the thus-generated track control signal. In accordance with the tracking control signal supplied by the tracking control circuit 27, the tracking actuator drive circuit 26 supplies the tracking actuator 7 with a tracking actuator drive current for actuating the tracking actuator 7 in a tracking direction. Thus, there is performed tracking servo operation by which the laser beam traces (follows) the track formed on the optical disk 40 at all times.

As a result of such focusing servo operation and tracking servo operation being performed, changes in the light reflected from pits, which are formed in the track of the optical disk 40 in response to recording information, are reflected on a reproduction (RF) signal corresponding to a total sum of detection signals from the photodetector 16 (respective photodetection cells). This reproduced signal is supplied to a data reproduction circuit 31 by the A/D converter 30. The data reproduction circuit 31 generates a binarized signal of one or zero in accordance with the reproduced signal supplied by the A/D converter 30, and the thus-generated binarized signal is output to an error correction circuit 32. Moreover, concurrently with outputting of a binarized signal to the error correction circuit 32, the data reproduction circuit 31 generates, as a PLL phase comparison signal, a phase difference between a reproduction clock signal supplied by a PLL (Phase-Locked Loop) circuit 29 and the binarized signal; and outputs the thus-generated PLL phase comparison signal to the PLL circuit 29.

In accordance with the reproduced signal supplied by the A/D converter 30 and the reproduction clock signal generated by the PLL circuit 29, a jitter measurement circuit 33 measures a jitter of the reproduced signal. A CPU 35 can read the thus-measured jitter measurement signal by a bus 34.

The DSP (Digital Signal Processor) 38 subjects, to various arithmetical processing operations, digital signals such as the focus error (FE) signal, the tracking error (TE) signal, and the like which are converted into digital signals by the A/D converter 30 after having been output from the RF amplifier 23, thereby controlling the spindle motor control circuit 4, a feed motor control circuit 22, the focus control circuit 25, and the tracking control circuit 27.

The DSP 38 controls the spindle motor control circuit 4, the feed motor control circuit 22, the focus control circuit 25, and the tracking control circuit 27 by the bus 34.

Moreover, the laser drive circuit 17, the PLL circuit 29, the A/D converter 30, the error correction circuit 32, the jitter measurement circuit 33, the DSP 38, and a temperature sensor 42 are controlled by the CPU (Central Processing Unit) 35 by the bus 34. The CPU 35 complies with an operation command supplied by the host machine 41 by the interface circuit 39; performs various processing operations in accordance with a program stored in ROM (Read Only Memory) 36 or a program loaded from ROM 36 into RAM (Random Access Memory) 37, to thus generate various control signals; and supplies respective sections with the thus-generated control signals, thereby collectively controlling the optical disk drive 1.

Incidentally, in the case of the optical disk drive 1, when a tracking offset particularly optimum for recording is determined, an optimum tracking offset varies according to the type and reflectance of a recording medium. Hence, tracking servo operation cannot be performed accurately in accordance with a change in the type or reflectance of a recording medium. Thus, tracking servo operation is performed while the beam spot position remains slightly deviated from a predetermined track position toward an inner or outer track.

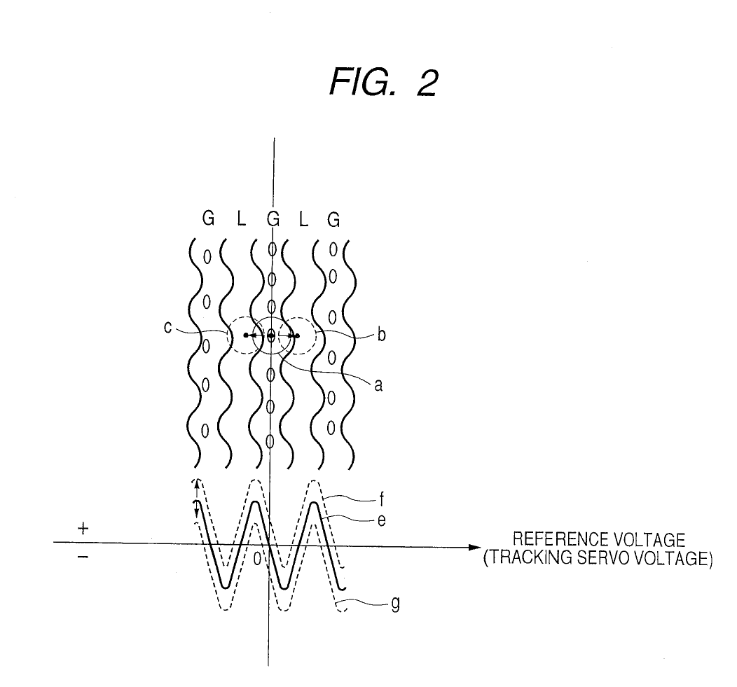

Specifically, as indicated by, e.g., a beam spot position “a” shown in FIG. 2, tracking servo is performed such that a beam spot position comes to a track position where a pit formed in the groove is located. However, when tracking servo operation cannot be performed accurately in accordance with a change in the type or reflectance of a recording medium, tracking servo operation is performed while the beam spot position remains slightly deviated from the predetermined track position toward an inner or outer track, as indicated by a beam spot position “b” or “c” in FIG. 2.

A tracking error signal is generated while the tracking servo voltage (e.g., the value of a preset voltage output from the tracking actuator drive circuit 26 for use in servo operation) is taken as a center voltage. When the beam spot position corresponds to the beam spot position “a,” a tracking error signal “e” captured by the DSP 38 becomes, at this time, equal to a tracking servo voltage at the center of the track position where the pit formed in the groove is present. However, the center of the tracking error signal deviates from the servo voltage, the tracking error signal “f” or “g” captured by the DSP 38 deviates up or down as compared with the tracking error signal “e” at this time.

A difference between a center voltage of a sinusoidal wave of the tracking error signal and a voltage value (a tracking servo voltage) serving as a reference is defined as a “tracking offset.”

Particularly, the laser beam to be emitted varies from the time of reproduction to the time of recording in terms of the power (the quantity of light) and gain of the laser beam. Hence, an optimum tracking offset varies from the time of reproduction to the time of recording. The optimum tracking offset is not inevitably proportional to the power (the quantity of light) and gain of the laser beam to be emitted at the time of reproduction and the time of recording. Therefore, difficulty is encountered in previously determining an optimum tracking offset at the time of recording. Accordingly, at the time of recording, tracking servo operation tends to be performed while the beam spot position remains slightly deviated from the predetermined track position toward the inner or outer track.

On this account, there has already been proposed a technique for enabling determination of an optimum tracking offset at the time of recording. According to the technique disclosed in US2002/2122362 A1, a tracking offset employed at the time of recording is made variable, to thus subject a plurality of frames of the optical disk to test recording. An optimum tracking offset can be computed and determined from a characteristic value of each of frames of a reproduced signal generated as a result of reproduction of the test-recorded portions of the plurality of frames. As a result, an optimum tracking offset can be determined at the time of recording, and occurrence of a reproduction jitter can be diminished.

There has also hitherto been known a technique of creating a pseudo recording state at the time of determination of an optimum tracking offset during reproduction operation and determining the tracking offset optimum for the created pseudo recording state as a tracking offset optimum for the time of recording.

The tracking offset optimum for the created pseudo recording state is defined as a “reference tracking offset.”

However, according to the technique disclosed in US2002/2122362 A1, a tracking offset employed at the time of recording is made variable, to thus subject a plurality of frames of an optical disk to test recording. An optimum tracking offset can be computed and determined from a characteristic value of each of frames of the signal formed by reproduction of test-recorded portions of the plurality of frames. However, a laser beam of recording power is emitted to a recording film of the optical disk, to thus record predetermined test data, and reproduction processing may be performed. Subsequently, the areas where the predetermined test data are recorded may be erased, and hence consumption of much time and efforts is taken by determination of a tracking offset optimum for recording.

Accordingly, for example, address information included in a wobble component previously formed in the track of the optical disk 40 is decoded and read during the course of OPC processing. A tracking offset at which an address information read rate serving as a rate for reading address information becomes maximum is determined as a recording-operation tracking offset used at the time of processing for recording data on an optical disk. The thus-determined recording-operation tracking offset employed at the time of processing for recording data on an optical disk is adjusted. As a result, a tracking offset optimum for the time of recording can be adjusted simply and accurately. OPC processing, which uses this method and is performed by the optical disk drive 1 shown in FIG. 1, will be described hereunder.

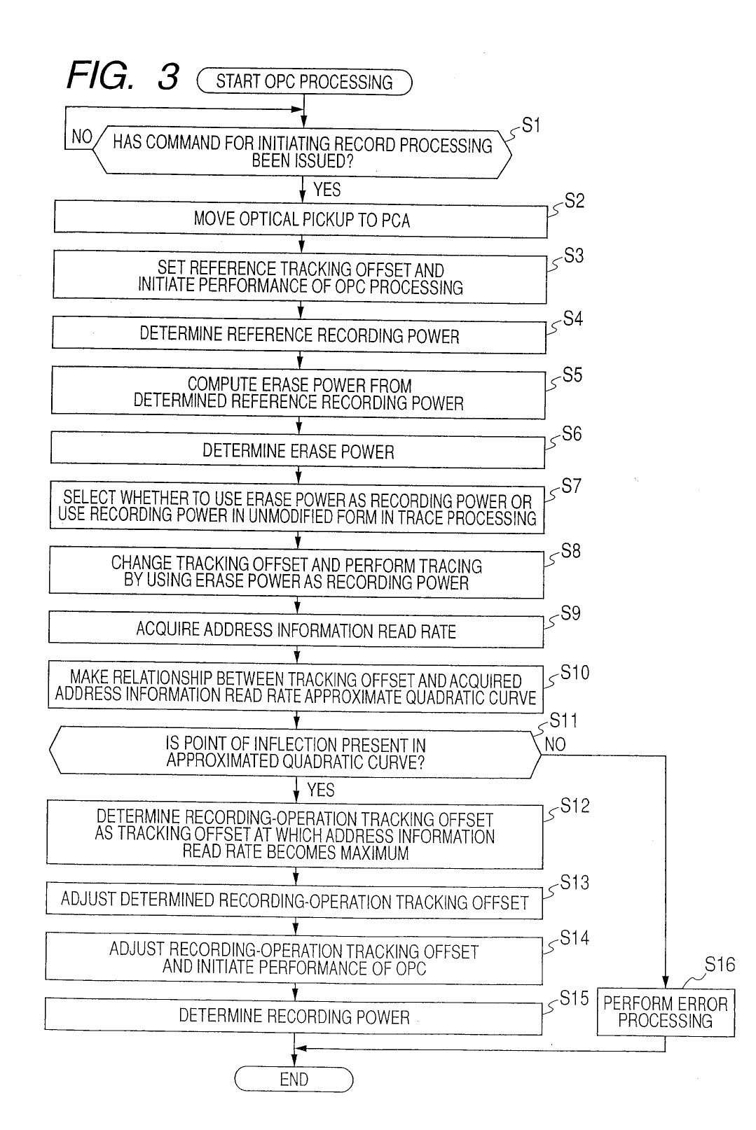

By reference to a flowchart shown in FIG. 3, OPC processing performed by the optical disk drive 1 shown in FIG. 1 will be described. This OPC processing is commenced when a command for starting processing for recording user data is issued as a result of the user operating an unillustrated input section of the host machine 41.

In step S1, the CPU 35 determines whether or not a command for commencing processing for recording user data has been issued as a result of the user having operated an unillustrated input section of the host machine 41. The CPU 35 enters a standby condition until a command for commencing processing for recording user data is determined to have been issued as a result of the user having operated the input section of the host machine 41.

When in step S1 a command for commencing processing for recording user data is determined to have been issued as a result of the user having operated the input section of the host machine 41, the CPU 35 controls the optical pickup 5 and the feed motor control circuit 22 in step S2, thereby actuating the optical pickup 5 to a power calibration area(PCA).

In step S3, the CPU 35 controls the optical pickup 5, the focus control circuit 25, the tracking control circuit 27, and the like, to thus set a previously-determined reference tracking offset and commence OPC processing. When OPC processing is performed, there is employed a method using asymmetry of a reproduced signal, a method using a jitter, or the like.

In step S4, the CPU 35 determines reference recording power which is determined by setting a reference tracking offset and performing OPC processing and which serves as a reference of recording power optimum for the optical disk 40.

In step S5, the CPU 35 controls and causes the DSP 38 to compute erase power from the determined reference recording power. The DSP 38 computes erase power from the determined reference recording power under control of the CPU 35.

In step S6, the CPU 35 determines erase power from a result of computation performed by the DSP 38.

In step S7, the CPU 35 selectively determines whether to use the erase power determined through tracking processing in step S8 as recording power or to use recording power. In the present embodiment, a selection is made, for instance, to use the determined erase power as recording power. As a matter of course, recording power may also be used in unmodified form.

In step S8, the CPU 35 controls the optical pickup 5, the focus control circuit 25, the tracking control circuit 27, and the like. Data in a predetermined portion of the power calibration area(PCA) on the optical disc 40 are tracked (traced) by using erase power as recording power while the tracking offset is changed within a predetermined range (e.g., −350 mV through 350 mV or the like).

In step S9, pursuant to control of the CPU 35, the DSP 38 decodes and reads address information included in wobble components formed in the optical disk 40 when tracking (tracing) data in the predetermined portion of the power calibration area(PCA) on the optical disk 40 by using erase power as recording power while changing the tracking offset within a predetermined range (e.g., −350 mV through 350 mV or the like), thereby acquiring an address information read rate.

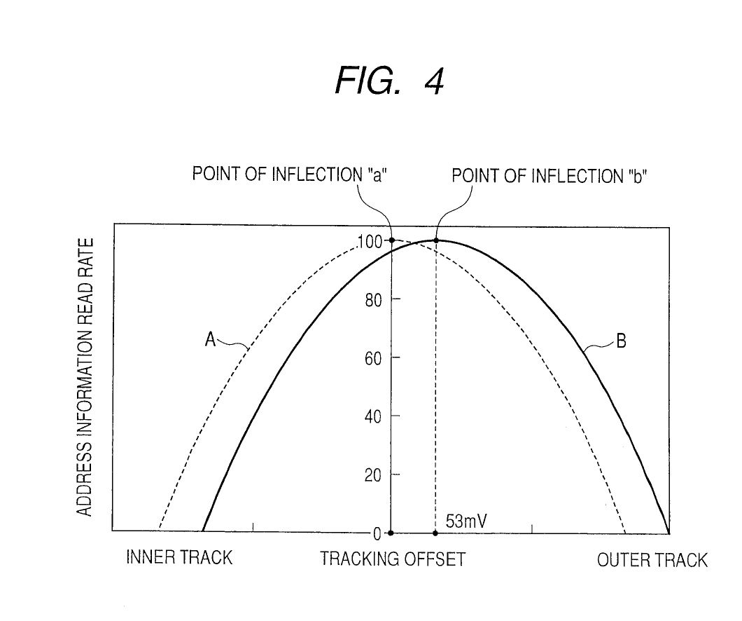

In step S10, pursuant to control of the CPU 35, the DSP 38 sets a relationship between the value of the changed tracking offset and the acquired address information read rate so as approximate a quadratic curve. For instance, as shown in FIG. 4, the vertical axis is set to an address information read rate, and the horizontal axis is set to the changed tracking offset. For instance, the relationship is made to approximate a quadratic curve, e.g., a parabola.

In step S11, pursuant to control of the CPU 35, the DSP 38 determines whether or not a point of inflection (e.g., the points of inflection “a” and “b” shown in FIG. 4) exists in the approximated quadratic curve. As shown in FIG. 4, the address information read rate becomes maximum at the points of inflection “a” and “b.”

When in step S11 a point of inflection (e.g., the points of inflection “a” and “b” shown in FIG. 4) is determined to exist in the approximated quadratic curve, in step S12 the CPU 35 determines, as a tracking offset at which the address information read rate becomes maximum, a recording-operation tracking offset used at the time of processing for recording data in the optical disk 40, pursuant to the command from the DSP 38. For instance, in the case of a dotted line A shown in FIG. 4, a tracking offset at which the address information read rate becomes maximum is 0 mV. Hence, there is no necessity for making a correction to the beam spot position. The recording-operation tracking offset used at the time of processing for recording data in the optical disk 40 is determined to be 0 mv. Meanwhile, in the case of, e.g., a solid line B shown in FIG. 4, the tracking offset at which the address information read rate becomes maximum is 53 mV. Hence, there is a necessity for making a correction to the beam spot position. The recording-operation tracking offset used at the time of processing for recording data in the optical disk 40 is determined to be 53 mV.

In step S13, the CPU 35 adjusts a recording-operation tracking offset used at the time of processing for recording data in the optical disk 40 by use of, e.g., a register (not shown) for the purpose of adjusting a tracking offset provided in the RF amplifier 23 and in accordance with the determined recording-operation tracking offset.

In step S14, the CPU 35 controls the optical pickup 5, the focus control circuit 25, and the tracking control circuit 27 and adjusts the recording-operation tracking offset (the recording-operation tracking offset used at the time of processing for recording data in the optical disk 40) determined through processing pertaining to step S12, thereby commencing performance of OPC processing. Likewise, for example, a method using asymmetry of a reproduced signal or a method using a jitter is used at the time of performance of OPC processing.

In step S15, the CPU 35 determines recording power which is determined by setting a recording-operation tracking offset and performing OPC processing and which is optimum for the optical disk 40.

Subsequently, OPC processing ends, and recording is performed by use of the optimum recording power that is determined through OPC processing and optimum for the optical disk 40.

Meanwhile, when the point of inflection (e.g., the point of inflection “a” shown in FIG. 4 or the like) is determined not to exist in the quadratic curve approximated in step S11, error processing is performed in step S16, and OPC processing is later completed. As a matter of course, address information read rate acquisition processing may also be performed a preset number of times.

In the embodiment, the preset reference tracking offset is adjusted, to thus perform OPC processing and determine reference recording power. The tracking offset is changed within a predetermined range by using the erase power computed from the determined reference recording power as recording powering, thereby tracking (tracing) data in the predetermined area of the power calibration area(PCA) on the optical disk 40. At the time of tracking (tracing) operation, the address information read rate included in the wobble components formed in the optical disk 40 is acquired. A relationship between the changed tracking offset and the acquired address information read rate is made to approximate a quadratic curve. A recording-operation tracking offset used at the time of processing for recording data in the optical disk 40 is determined as a tracking offset at which the address information read rate becomes maximum at a point of inflection in the approximated quadratic curve, and the determined recording-operation tracking offset is adjusted. Accordingly, there is no necessity for encoding record data during OPC processing and decoding reproduction data. A tracking offset optimum for recording can be adjusted simply and accurately.

Moreover, data in a predetermined area of the power calibration area(PCA) on the optical disk 40 are tracked without use of recording power and (traced) by using erase power as recording power. Accordingly, a tracking offset optimum for recording is determined efficiently without wastefully writing the power calibration area (PCA) with data, and a determined recording-operation tracking offset can be adjusted.

A recording-operation tracking offset used at the time of processing for recording data in the optical disk 40 is determined as a tracking offset at which an address information read rate becomes maximum. Accordingly, occurrence of a recording error (write error), which would otherwise be caused by a failure to read address information at the time of recording, can be prevented.

Moreover, OPC processing is performed by adjustment of the determined recording-operation tracking offset, thereby determining recording power used at the time of processing for recording data in the optical disk 40. Accordingly, a correction is made to the reference recording power (reference recording power serving as a reference of recording power optimum for the optical disk 40) determined by setting the reference tracking offset and performing OPC processing, so that recording power more optimum for the optical disk 40 can be determined.

As mentioned above, recording quality of the optical disk 40 can be enhanced.

Incidentally, in OPC processing described by reference to the flowchart shown in FIG. 3, a recording-operation tracking offset used at the time of processing for recording data in the optical disk 40 is determined by use of the address information included in the wobble components previously formed in the optical disk 40, and the determined recording-operation tracking offset is adjusted. However, for example, there may also be performed monitoring of a transient response appearing when a predetermined area of the optical disk is exposed while reproduction power (reading power) and erase power computed from reference recording power are switched with each other; computing of a difference between tracking error signals responsive to the monitored transient responses; determining, from the computed difference between the tracking error signals, a recording-operation tracking offset used at the time of processing for recording data in an optical disk; and adjusting the determined recording-operation tracking offset used at the time of processing for recording data in the optical disk. As a result, a tracking offset optimum for the time of recording can be adjusted simply, accurately, and quickly. OPC processing performed by the optical disk drive 1 that uses this method and is shown in FIG. 1 will be described hereunder.

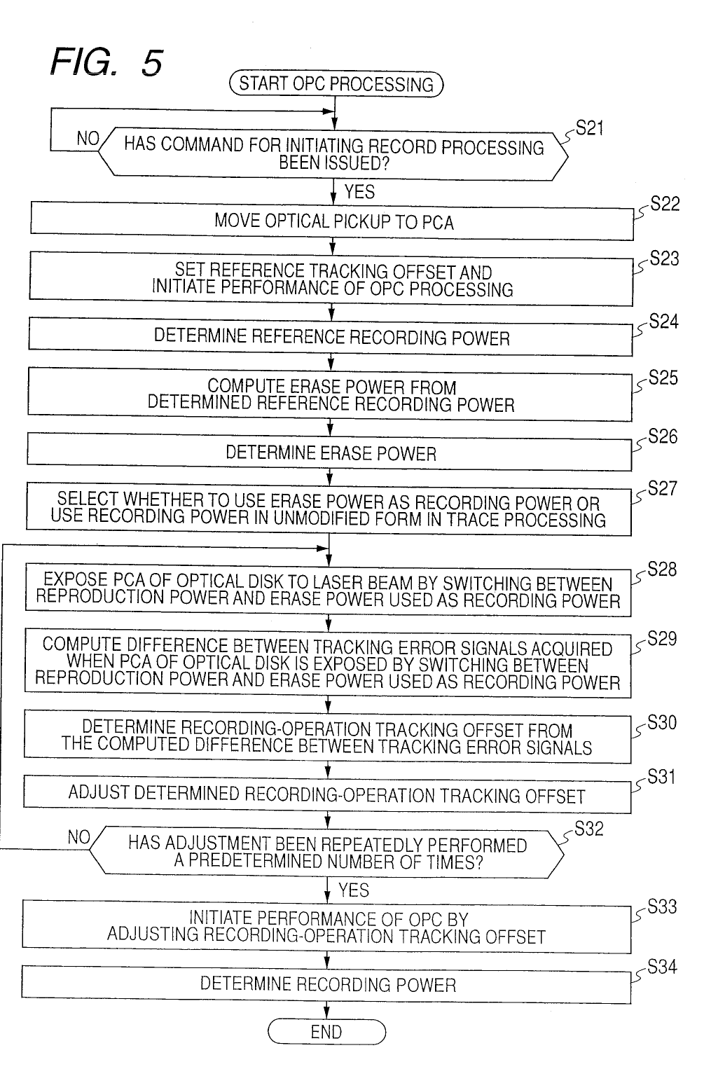

By reference to an exemplary flowchart shown in FIG. 5, other OPC processing performed in the optical disk drive 1 shown in FIG. 1 will be described. Processing pertaining to steps S21 through S27 shown in FIG. 5 and processing pertaining to steps S33 and S34 are basically analogous to processing pertaining to steps S1 through S7 shown in FIG. 3 and processing pertaining to steps S14 and S15, and their repeated explanations are omitted here for clarity.

In step S28, the CPU 35 controls the optical pickup 5, the focus control circuit 25, and the tracking control circuit 28; and irradiates the power calibration area(PCA) in the optical disk 40 while switching reproduction power and the erase power that is computed from reference recording power and used as recording power.

In step S29, pursuant to control of the CPU 35, the DSP 38 monitors a transient response which appears when the power calibration area(PCA) of the optical disk 40 is exposed by switching between reproduction power and the erase power that is computed from reference recording power and is used as recording power; and computes a difference between the tracking error signals in the monitored transient responses.

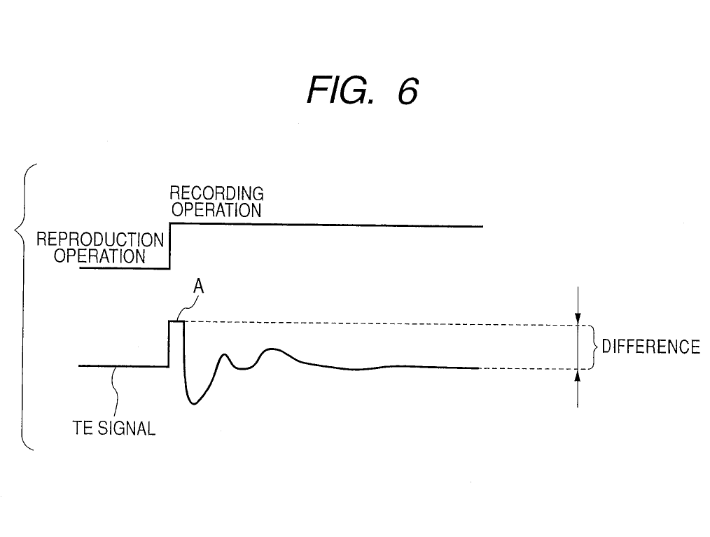

Specifically, as shown in FIG. 6, when the power calibration area(PCA) of the optical disk 40 is exposed while switching is made between the reproduction power and the erase power that is computed from the reference recording power and is used as recording power, a transient response A appears. The tracking error signal captured by the DSP 38 momentarily ascends or descends. At this time, a difference between the tracking error signals is computed such that the transient response A disappears.

For instance, after determination of the tracking offset optimum for reproduction, the determined tracking offset for reproduction is adjusted, and a center voltage of the tracking error signal is accurately matched with the servo voltage (e.g., 1.65 V) output from the tracking actuator drive circuit 26. In such a case, when the reference tracking offset is adjusted, the center voltage of the tracking error signal momentarily ascends to, e.g., 1.85 V and then descends to a level equivalent to the servo voltage (e.g., 1.65 V) output from the tracking actuator drive circuit 26. A difference between the tracking error signals acquired at this time is computed as −0.2 V=1.65 V−1.85 V.

In step S30, the CPU 35 determines, from the difference between the tracking error signals computed by the DSP 38, a recording-operation tracking offset used at the time of processing for recording data into the optical disk 40.

For instance, when a difference between tracking error signals is computed as −0.2 V=1.65 V −1.85 V when the power calibration area (PCA) of the optical disk 40 is exposed by switching between reproduction power and erase power that is computed from the reference recording power and is used as recording power, the recording-operation tracking offset used at the time of processing for recording data in the optical disk 40 is determined as −0.2 V (−200 mV).

In step S31, the CPU 35 adjusts the recording-operation tracking offset, which is used during processing for recording data onto the optical disk 40, by use of, e.g., a register (not shown) for adjusting a tracking offset provided in the RF amplifier 23 and in accordance with the determined recording-operation tracking offset.

In step S32, the CPU 35 determines whether or not recording-operation tracking offset adjustment processing has been repeatedly performed a predetermined number of times (e.g., three times or the like) in steps S28 through S31.

When in step S32 recording-operation tracking offset adjustment processing is determined not to have been repeatedly performed a predetermined number of times (e.g., three times or the like) in steps S28 through S31, processing returns to step S28, and processing pertaining to step S28 and subsequent steps is iterated. As a result, recording-operation tracking offset adjustment processing pertaining to steps S28 through S31 is repeatedly performed a predetermined number of times (e.g., three times or the like), and the recording-operation tracking offset is adjusted such that a transient response substantially disappears.

When in step S32 recording-operation tracking offset adjustment processing is determined to have been repeatedly performed a predetermined times (e.g., three times or the like) in steps S28 through S31, processing proceeds to step S33. OPC processing is performed by adjustment of the recording-operation tracking offset, whereby recording power optimum for the time of processing for recording data into the optical disk 40 can be determined.

In the present embodiment, OPC processing is performed by adjusting a predetermined reference tracking offset, thereby determining reference recording power. There is monitored a transient response acquired when a power calibration area (PCA) of the optical disk 40 is exposed while switching reproduction power and erase power used as recording power computed from the reference recording power. A difference between tracking error signals derived from monitored transient responses is computed, and a recording-operation tracking offset used during processing for recording data in the optical disk 40 is determined from the computed difference between the tracking error signals. The determined recording-operation tracking offset is adjusted. Accordingly, in OPC processing there is no necessity for performing processing for encoding record data and processing for decoding reproduced data. So long as the time-recording optimum tracking offset can be adjusted more simply and accurately, a tracking offset can be more readily, accurately, and quickly adjusted during recording operation.

The power calibration area (PCA) of the optical disk 40 is exposed without use of recording power and by using erase power as recording power. Accordingly, a recording-operation tracking offset optimum for the time of recording is efficiently determined without wastefully filling the power calibration area (PCA) with data, and the determined recording-operation tracking offset can be adjusted.

Moreover, OPC processing is performed by adjusting the determined time-recording tracking offset, and recording power used for the time of processing for recording data onto the optical disk 40 is determined. Accordingly, reference recording power (the reference recording power serving as a reference of recording power optimum for the optical disk 40) determined by setting a reference tracking offset and performing OPC processing is corrected, and optimum recording power can be determined for the optical disk 40.

As mentioned above, the recording quality of the optical disk 40 can be enhanced.

Incidentally, for instance, one track is jumped, and a center between the peak and bottom of the tracking error signal acquired at that time is computed. A difference between the tracking error signal and the reference value [a servo voltage (e.g., 1.65 V or the like) output from a tracking actuator drive circuit 26] is computed from the center of the computed tracking error signal. The recording-operation tracking offset used at the time of processing for recording data onto the optical disk is determined from the thus-computed difference between the tracking error signal and the reference value (the tracking servo voltage serving as a reference voltage). The determined recording-operation tracking offset used at the time of processing for recording data into an optical disk may also be adjusted. As a result, a tracking offset optimum for the time of recording can be readily and accurately adjusted. OPC processing performed by the optical disk drive 1 shown in FIG. 1 will be described hereunder by use of this method.

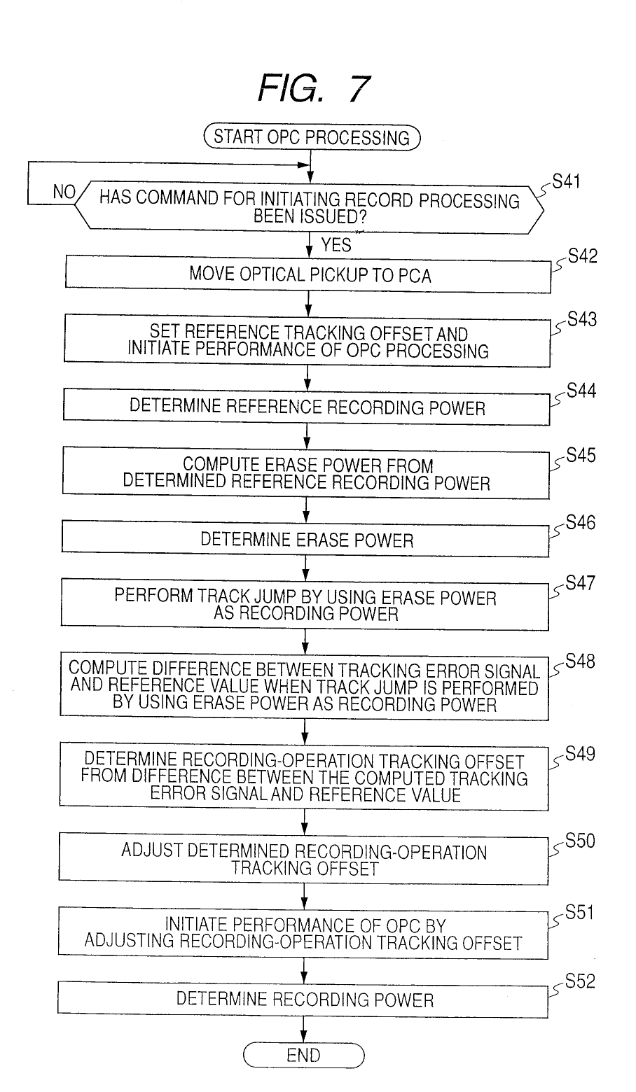

By reference to the flowchart shown in FIG. 7, other OPC processing performed by the optical disk drive 1 shown in FIG. 1 will be described. Processing pertaining to steps S41 through S46 and processing pertaining to steps S51 and S52 shown in FIG. 7 are basically analogous to processing pertaining to steps S1 through S6 and processing pertaining to steps S14 and S15 shown in FIG. 3, and their repeated explanations are omitted here for clarity.

In step S47, the CPU 35 controls the optical pickup 5, the focus control circuit 25, and the tracking control circuit 27. A track jump equivalent to a distance of, e.g., one track, is carried out in the power calibration area (PCA) of the optical disk 40 by using the thus-determined erase power as recording power. As a matter of course, the distance over which jump is performed is not limited to one track.

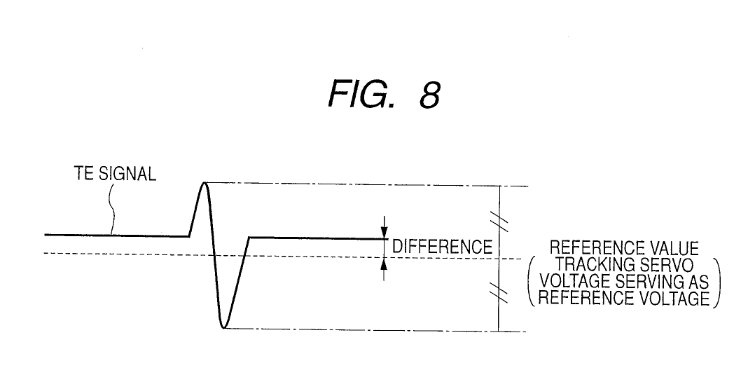

At this time, for instance, a tracking error signal such as that shown in FIG. 8 is captured by the DSP 38.

In step S48, pursuant to control of CPU 35, the DSP 38 computes a center between the peak and bottom of the tracking error signal acquired when a jump over a distance equivalent to one track is performed. A difference between a tracking error signal and the reference value [a tracking servo voltage (e.g., 1.65 V or the like) serving as a reference voltage] is computed from the computed center of the tracking error signal.

For instance, when the center of the tracking error signal is 2.0 V, a difference between the tracking error signal and the reference value [a tracking servo voltage (e.g., 1.65 V or the like) serving as a reference voltage] is computed as 0.35 V (350 mV)=1.65 V −2.0 V.

In step S49, the CPU 35 computes the recording-operation tracking offset used at the time of processing for recording data onto the optical disk 40, from the difference between the tracking error signal and the reference value computed by the DSP 38.

For instance, when a difference between the tracking error signal and the reference value [a tracking servo voltage (e.g., 1.65 V or the like) serving as a reference voltage] is computed as −0.35 V=1.65 V −2.0 V, the recording-operation tracking offset used at the time of processing for recording data onto the optical disk 40 is determined to be −0.35V (−350 mV).

In step S50, the CPU 35 adjusts the recording-operation tracking offset used at the time of processing for recording data onto the optical disk 40, by use of, e.g., a register (not shown) for adjusting a tracking offset provided in the RF amplifier 23 and in accordance with the determined recording-operation tracking offset.

Subsequently, processing proceeds to step S51. Recording power optimum for the time of processing for recording data onto the optical disk 40 can be determined by adjusting the recording-operation tracking offset and performing OPC processing.

In the present embodiment, OPC processing is performed by adjusting the predetermined reference tracking offset, to thus to determine reference recording power. A track jump over a distance equal to one track is performed in the power calibration area (PCA) of the optical disk by using the erase power computed from the reference recording power as recording power. A difference between the tracking error signal performed when track jump corresponding to one track is performed and the reference value (the tracking servo voltage serving as the reference voltage) is computed. From the difference between the computed tracking error signal and the reference value, a recording-operation tracking offset used at the time of processing for recording data onto the optical disk 40 is determined. The determined recording-operation tracking offset is adjusted, and hence there is no necessity for processing for encoding record data and reproduction operation (reproduction processing) in OPC processing. A tracking offset optimum for the time of recording operation can be adjusted more simply and accurately. As a result, tracking can be performed at the center of the servo. Even when disturbance, such as flaws or vibration, is imparted during the course of processing for recording data onto the optical disk 40, tracking servo processing can be performed stably. Durability to disturbance, such as flaws and vibration, can be enhanced.

The power calibration area(PCA) of the optical disk 40 is exposed without use of recording power and by using erase power as recording power. Accordingly, a recording-operation tracking offset optimum for recording is determined efficiently without wastefully filling the power calibration area(PCA) with data, and the determined recording-operation tracking offset can be adjusted.

Moreover, the determined recording-operation tracking offset is adjusted, to thus perform OPC processing, and recording power used at the time of processing for recording data onto the optical disk 40 is determined. Accordingly, the reference recording power (reference recording power serving as a reference of recording power optimum for the optical disk 40) determined by setting the reference tracking offset and performing OPC processing is corrected, and optimum recording power can be determined by the optical disk 40.

As mentioned above, recording quality of the optical disk 40 can be enhanced.

In the embodiment, the DSP 38 performs arithmetic processing or the like. However, the CPU 35 may perform arithmetic operation in place of the DSP 38.

When the recording-operation tracking offset is adjusted by use of erase power, a rewritable disk, such as a CD-RW, a DVD-RW, or the like, can be used for the optical disk 40. Moreover, when the recording-operation tracking offset is adjusted by use of recording power, a once-recordable disk may also be used for the optical disk 40. Alternatively, a rewritable disk, such as a CD-RW, a DVD-RW, or the like, may be used.

In the present embodiment, steps of a flowchart illustrate example processing performed in time sequence along the described sequence. Processing which is not necessarily performed in time sequence, but may be performed in parallel or individually.

According to the above-described embodiment, a tracking offset optimum for the time of recording can be adjusted readily and accurately.

While certain embodiments of the inventions have been described, these embodiments have been presented by example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk apparatus comprising:
a first determination unit configured to set a reference tracking offset and determine a reference recording power by an optimum power control processing;
a tracing unit configured to trace a predetermined area in an optical disk by changing the tracking offset through use of an erase power calculated from the reference recording power;
an acquisition unit configured to acquire an address information acquisition rate serving as a rate for reading address information, when data are traced in the predetermined area of the optical disk by changing the tracking offset within a predetermined range by the tracing unit;
a second determination unit configured to determine, from the address read rate, a recording-operation tracking offset used during processing for recording the data into the optical disk; and
an adjustment unit configured to adjust the recording-operation tracking offset.

2. The optical disk apparatus according to claim 1, comprising:
a recording power determination unit configured to determine a recording power used when the data is recorded into the optical disk through OPC processing after the adjustment unit adjusts the recording-operation tracking offset.

3. The optical disk apparatus according to claim 1, wherein the second determination unit determines the recording-operation tracking offset used when the data is recorded into the optical disk as a tracking offset at which the address read rate acquired by the acquisition unit become a maximum value.

4. An optical disk recording method comprising:
setting a reference tracking offset;
determining a reference recording power by an optimum power control processing;
tracing a predetermined area in an optical disk by changing the tracking offset through use of an erase power calculated from the reference recording power;
acquiring an address information acquisition rate serving as a rate for reading address information, when data are traced in the predetermined area of the optical disk by changing the tracking offset within a predetermined range by the tracing unit;
determining, from the address read rate, a recording-operation tracking offset used during processing for recording the data into the optical disk; and
adjusting the recording-operation tracking offset.

5. An optical disk apparatus comprising:
a first determination unit configured to set a reference tracking offset and determine a reference recording power by an optimum power control processing;
a calculating unit configured to calculate a difference between a tracking error signal acquired when a predetermined area in an optical disk is exposed by switching reproduction power and an erase power calculated from the reference recording power;
a second determination unit configured to determine, from the difference, a recording-operation tracking offset used when a data is recorded into the optical disk; and
an adjustment unit configured to adjust the recording-operation tracking offset.

6. The optical disk apparatus according to claim 5, comprising:
a recording power determination unit configured to determine a recording power used when a data is recorded into the optical disk through the optimum power control processing after the adjustment unit adjusts the recording-operation tracking offset.

7. The optical disk apparatus according to claim 5, wherein the adjustment unit adjusts the recording-operation tracking offset by repeating adjustment a predetermined number of times.

8. An optical disk recording method comprising:
setting a reference tracking offset;
determining a reference recording power by an optimum power control processing;
calculating a difference between a tracking error signal acquired when a predetermined area in an optical disk is exposed by switching reproduction power and an erase power calculated from the reference recording power;
determining, from the difference, a recording-operation tracking offset used when a data is recorded into the optical disk; and
adjusting the recording-operation tracking offset.

9. An optical disk apparatus comprising:
a first determination unit configured to set a reference tracking offset and determine a reference recording power by an optimum power control processing;
a calculating unit configured to calculate a difference between a tracking error signal and a predetermined reference value when a track jump is performed in a predetermined area of an optical disk through use of an erase power calculated from the reference recording power;
a second determination unit configured to determine, from the difference, a recording-operation tracking offset used when a data is recorded onto the optical disk; and
an adjustment unit configured to adjust the recording-operation tracking offset.

10. The optical disk apparatus according to claim 9, comprising:
a recording power determination unit configured to determine a recording power used when the data is recorded onto the optical disk through the optimum power control processing after the adjustment unit adjusts the recording-operation tracking offset.

11. An optical disk recording method comprising:
setting a reference tracking offset;
determining a reference recording power by an optimum power control processing;
calculating a difference between a tracking error signal and a predetermined reference value when a track jump is performed in a predetermined area of an optical disk through use of an erase power calculated from the reference recording power;
determining, from the difference, a recording-operation tracking offset used when a data is recorded onto the optical disk; and
adjusting the recording-operation tracking offset.
